(19) United States
(12) Patent Application Publication
(10) Pub. No.: US 2008/0130065 A1
(43) Pub. Date: Jun. 5, 2008

(54) IMAGE FORMING APPARATUS

(75) Inventor: Daijiro Saito, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 11/934,377

(22) Filed: Nov. 2, 2007

(30) Foreign Application Priority Data
Nov. 2, 2006 (JP) 2006-299130
Oct. 12, 2007 (JP) 20070-266758

(51) Int. Cl. H04N 1/04

(52) U.S. Cl. 358/474

(57) ABSTRACT

An image forming apparatus includes each write unit for each color, in which light emitting elements are arrayed in line in a main scanning direction to superimpose images based on image data of each color and to form a color image; a first write unit in which a resolution specification of an array of the light emitting elements is a first resolution; a second write unit in which a resolution specification of an array of the light emitting elements is a second resolution; a scale factor setting unit for setting a scale factor in the main scanning direction of the image data of the color corresponding to the first write unit or the second write unit based on the first resolution and the second resolution; and a scaling unit for scaling the image data in the main scanning direction based on the set scale factor.

### BACKGROUND OF THE INVENTION

1. Field of the Invention

The present invention relates to an image forming apparatus.

2. Description of the Related Art

Heretofore, there has been an image forming apparatus which forms electrostatic latent images on photoconductor drums based on inputted image data by light emitting diode (hereinafter referred to as LED)-head write optical systems in which writing elements such as a plurality of LEDs are arranged in lines, and transfers toner images formed by adhering toners on the electrostatic latent images to a recording medium such as paper and fixes the toner images to form an image. The image forming apparatus includes the LED-head write optical systems arranged in lines for each color of yellow (Y), magenta (M), cyan (C) and black (BK), superimposes the images formed by using the LED-head write optical systems for each color, and transfers the superimposed images to form a color image on the recording medium.

For example, in Japanese Patent Laid-Open Publication No. 2006-5591, the image forming apparatus for forming the color image by the LED-head write systems is disclosed. It is disclosed that by executing interpolation for the image data per line and per pixel based on a scale factor as magnification for reducing or enlarging the image or/and by executing the interpolation processing, a good image which is not influenced by fine changes of the magnification at a pixel unit level is formed on the recording medium.

Moreover, in recent years, LED write units having various resolution specifications such as 600 dpi and 1200 dpi have been used. Also in the color image forming apparatus configured as described above, in some cases, LED write units having different resolution specifications between colors are used. For example, there is a case where the write unit having higher resolution 1200 dpi is used for BK and the write unit having lower resolution 600 dpi is used for each color of Y, M and C. However, the resolutions of the actual LED write units are slightly shifted from the required resolutions, such as 600.5 dpi and 1198.0 dpi, owing to the specifications of the LED write units. In the case of using the write units having the resolution specifications as described above, there is a problem that positions of dots are shifted between the colors by using the write units having the different resolution specifications and the color shift is caused.

The above-described conventional technology is one for scaling the image in accordance with a shape of the recording medium, and performing the image forming in accordance with the shape of the recording medium. The conventional technology could not prevent the color shift by adjusting a degree of superposition of the colors included in the image to be formed.

### SUMMARY

The present invention is made in consideration of the problem inherent in the above-described conventional technology. It is an object of the present invention to prevent the color shift when the color image is formed.

In order to achieve at least one of the aforementioned objects, an image forming apparatus reflecting one aspect of the present invention, comprising each write unit for each color, in which light emitting elements are arrayed in line in a main scanning direction to superimpose images based on image data of each color and to form a color image;

a first write unit in which a resolution specification of an array of the light emitting elements is a first resolution;

a second write unit in which a resolution specification of an array of the light emitting elements is a second resolution;

a scale factor setting unit for setting a scale factor in the main scanning direction of the image data of the color corresponding to the first write unit or the second write unit based on the first resolution and the second resolution; and

a scaling unit for scaling the image data in the main scanning direction based on the set scale factor.

In the above-described image forming apparatus, preferably, the first resolution of the first write unit is higher than the second resolution of the second write unit, and the scale factor setting unit sets the scale factor in the main scanning direction of the image data of the color corresponding to the first write unit.

In the above-described image forming apparatus, preferably, the first write unit writes an image of black (BK), and the second write units writes an image of any one of cyan (C), magenta (M) and yellow (Y).

In the above-described image forming apparatus, preferably, the scale factor setting unit sets the scale factor in the main scanning direction of the image data of any one color to a scale factor in which a ratio between the first resolution and the second resolution is an integer.

In the above-described image forming apparatus, preferably, a monochrome mode of performing an image forming by using only the first write unit, and a color mode of performing the image forming by using all of the write units are provided, and

the scale factor setting unit sets the scale factor based on the first resolution and the second resolution when the color mode is selected, and are inhibited from setting the scale factor based on the first resolution and the second resolution when the monochrome mode is selected.

In the above-described image forming apparatus, preferably, the image forming apparatus further comprises:

a storage unit for storing each resolution information of the first write unit and the second write unit,

wherein the scale factor setting unit calculates and sets the scale factors based on the resolution information of the first write unit and the second write unit, which is read out from the storage unit.

In the above-described image forming apparatus, preferably, the image forming apparatus further comprises:

an operation unit for receiving an operation from a user, wherein resolution information inputted from the operation unit is stored in the storage unit as the resolution information of the first write unit and the second write unit.

In the above-described image forming apparatus, preferably, the image forming apparatus further comprises:

a gradation conversion unit for converting a gradation of the image data of each color,

wherein the scaling unit scales the image data of which the gradation is converted.

In the above-described image forming apparatus, preferably, the gradation conversion unit binarizes the gradation of the image data of each color, and the gradation conversion unit performs pixel thinning or pixel insertion in the main scanning direction for the image data of each color, of which the gradation is binarized, based on the set scale factor.

In the above-described image forming apparatus, preferably, the gradation conversion unit randomly performs the pixel thinning or the pixel insertion in the main scanning direction for pixels in the main scanning direction.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a schematic view showing an internal configuration of a color copier;

FIG. 2 is a perspective view illustrating configurations of write units and a peripheral circuit thereof;

FIG. 3 is a bock diagram schematically showing a configuration of a control system of the color copier;

FIG. 4 is a block diagram illustrating the configuration of each write unit for the colors of Y, M, C and BK and the peripheral circuit thereof;

FIG. 5 is a block diagram schematically showing a configuration of an image processing unit;

FIG. 6 is a flowchart illustrating operations of the color copier; and

FIG. 7 is a conceptual view illustrating the image forming on a recording medium by the write unit.

### DETAILED DESCRIPTION OF THE PREFERRED EMBODIMENT

A description will be made below of an embodiment of the present invention with reference to the drawings; however, the present invention is not limited to the following embodiment.

Moreover, the embodiment of the present invention illustrates the best mode of the invention, and the intented purpose and the terms of the invention are not limited to this.

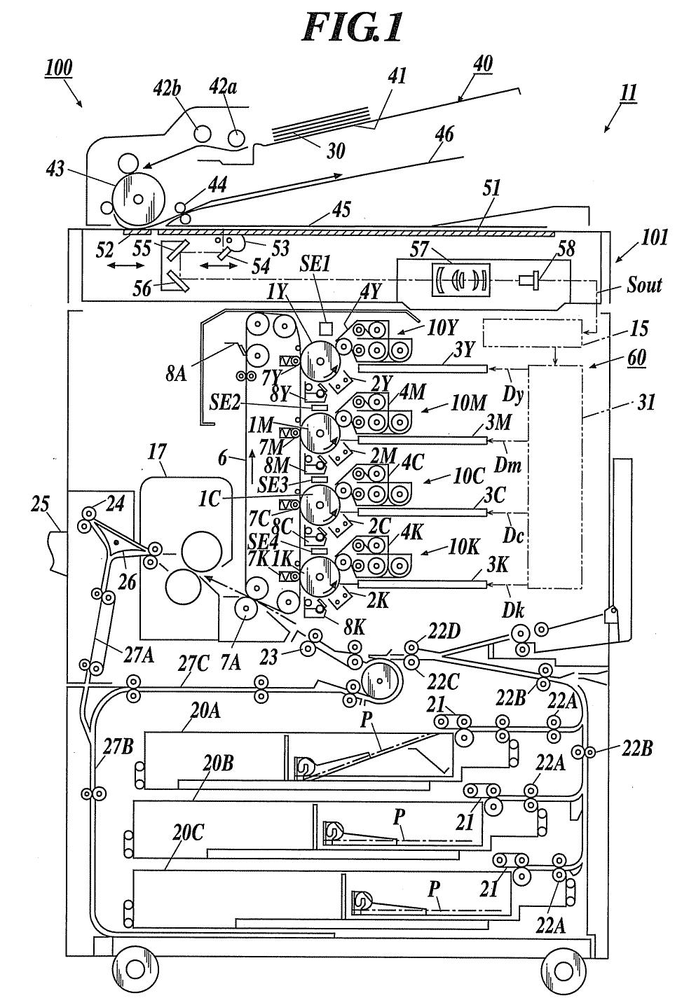

First, a description will be briefly made of a configuration of a color copier 100. As shown in FIG. 1, the color copier 100 is an apparatus having a function as an image processing apparatus that performs image processing for image data obtained by scanning an original, and a function as an image forming apparatus that forms color images on recording media P based on the image data for which the image processing has been performed. This color copier 100 may be applied to a color printer, a color facsimile machine, and a multi-function peripheral thereof.

The color copier 100 includes a copier body 101. On an upper portion of the copier body 101, a color image input unit 11 and an automatic document feeder (ADF) 40 are arranged. The ADF 40 operates so as to automatically feed one or a plurality of originals 30 at the time of an ADF mode. Here, the ADF mode mentioned here refers to an operation to automatically feed the originals 30 mounted on the ADF 40 and then to automatically read images of the originals.

The ADF 40 includes: an original mounting portion 41; a roller 42a; a roller 42b; a roller 43; conveyor rollers 44; and an original receiving tray 46. On the original mounting portion 41, one or more originals 30 are mounted. On a downstream side of the original mounting portion 41, the roller 42a and the roller 42b are provided. When the ADF mode is selected, the originals 30 fed out of the original mounting portion 41 are conveyed by the roller 43 on a downstream side so as to perform a U rotation. Note that, when the ADF mode is selected, the originals 30 are mounted on the original mounting portion 41 while facing recording surfaces thereof upward.

Meanwhile, the color image input unit 11 operates so as to read the color images formed on the originals 30. For the image input unit 11, for example, a color scanner of a slit scan type is used. In the image input unit 11, an image sensor 58 in which a plurality of light receiving elements are arrayed is provided. For example, the image sensor 58 is adapted to read the surfaces of the originals 30 and to output image reading signals Sout when the originals 30 are inverted in a U shape by the roller 30 at the time of the ADF mode. For the image sensor 58, for example, a 3-line CCD (color charge coupled device) image pickup device is used.

In the image sensor 58, three reading sensors for detecting color rays of red (R), green (G) and blue (B) are composed in such a manner that a plurality of arrays of light receiving elements are arranged in a main scanning direction. The image sensor 58 is adapted so that the three reading sensors can divide pixels at different positions in a sub scanning direction perpendicular to the main scanning direction and can simultaneously read optical information of the colors of R, G and B.

The originals 30 read in the image input unit 11 are conveyed by the conveyor rollers 44 and discharged to the original receiving tray 46. Meanwhile, the image sensor 58 is adapted to output image reading signals of the RGB color system, which are obtained by reading the originals 30, at the time of a platen mode. Here, the platen mode refers to an operation to run an optical drive system for scanning the originals 30 mounted on platen glass and to automatically read the originals.

Besides the image sensor 58, the image input unit 11 includes: first platen glass 51; second platen glass 52 (ADF glass); a light source 53; mirrors 54, 55 and 56; an image forming optical unit 57; and an optical drive unit (not particularly shown). The light source 53 operates so as to irradiate light onto the originals 30. The optical drive unit operates so as to move the originals 30 or the image sensor 58 relatively in the sub scanning direction. The sub scanning direction refers to a direction perpendicular to the main scanning direction when a direction where the plurality of light receiving elements composing the image sensor 58 are arranged is defined as the main scanning direction. As described above, the originals 30 mounted on the original mounting portion 41 of the ADF 40 are conveyed by the above-described rollers 42a, 42b and 43 and the conveyor rollers 44, the images on one-side or both-side surfaces of the originals 30 are scanned and exposed by the optical system of the image input unit 11, and incident light that reflects such image reading is read by the image sensor 58.

The image sensor 58 performs photoelectric conversion for the incident light. An image processing unit 31 is connected to the image sensor 58 through a control unit 15. In the image processing unit 31, analog processing, A/D conversion, shading correction, image compression processing, scaling processing, and the like are carried out for analog image reading signals for which the photoelectric conversion has been performed. Then, the image reading signals become digital image data in which the respective pixels are expressed by color components of R, G and B.

The image processing unit 31 converts the image data into image data Dy, Dm, Dc, Dk for colors of yellow (Y), magenta (M), cyan (C) and black (BK) by a three-dimensional color information conversion table. The scaling information 321 for each write unit, which is stored in a storage unit, is read out by a control unit to be described later. Then, for the image data Dy, Dm, Dc, Dk, the scaling processing is performed based on a control instruction outputted to the image processing unit 31. The image data Dy, Dm, Dc and Dk for which the scaling processing has been performed are transferred to the write units 3Y, 3M, 3C and 3K composing an image forming section 60.

The copier body 101 includes the plurality of write units which form the respective color images of Y, M, C and BK, and is one referred to as a tandem-type color image forming apparatus that forms the color images on the recording media such as paper. In the copier body 101, the image forming section 60 is provided. After the originals are read by the image input unit 11, the image forming section 60 forms the color images based on the image data for which the image processing has been performed, in the image processing unit 31. The image forming section 60 includes: a plurality of image forming units 10Y, 10M, 10C and 10K, each of which has an image forming body for each color; an endless intermediate transfer body 6; and a fixation device 17 for fixing the toner images which are transferred to the recording media from the intermediate transfer body 6.

The image forming unit 10Y that forms the color image of yellow (Y) includes: a photoconductor drum 1Y as an image forming body that forms the toner image of the color of Y; a charging unit 2Y for the color of Y, which is disposed on a circumference of the photoconductor drum 1Y; a write unit 3Y; a developing unit 4Y; and a cleaning member 8Y for the image forming body. The image forming unit 10M that forms the color image of magenta (M) includes: a photoconductor drum 1M as an image forming body that forms the toner image of the color of M; a charging unit 2M for the color of M; a write unit 3M; a developing unit 4M; and a cleaning member 8M for the image forming body.

The image forming unit 10C that forms the color image of cyan (C) includes: a photoconductor drum 1C as an image forming body that forms the toner image of the color of C; a charging unit 2C for the color of C; a write unit 3C; a developing unit 4C; and a cleaning member 8C for the image forming body. The image forming unit 10K that forms the color image of black (BK) includes: a photoconductor drum 1K as an image forming body that forms the toner image of the color of BK; a charging unit 2K for the color of BK; a write unit 3K; a developing unit 4K; and a cleaning member 8K for the image forming body.

The charging unit 2Y and the write unit 3Y, the charging unit 2M and the write unit 3M, the charging unit 2C and the write unit 3C, and the charging unit 2K and the write unit 3K form electrostatic latent images on the intermediate transfer body. For the write units 3Y, 3M, 3C and 3K, LED array head optical systems in which light emitting elements (light emitting elements for writing) for performing the image forming are arranged in lines in the main scanning direction perpendicular to a conveying direction (sub scanning direction) of the recording media on which the images are to be formed, are used.

Development by the develop units 4Y, 4M, 4C and 4K is performed by the inversion development in which developing biases in which alternating voltages are superimposed on direct voltages with the same polarity (for example, a negative polarity) as a polarity of toners for use, are applied. The intermediate transfer body 6 is wound around a plurality of rollers, is rotatably supported, and transfers the toner images of the colors of Y, M, C and BK, which are formed on each of the photoconductor drums 1Y, 1M, 1C and 1K.

Note that, in arrangement of the light emitting elements in the write units 3Y, 3M, 3C and 3K, element densities per unit length, that is, resolutions, and a length between the light emitting elements on both ends in the main scanning direction, that is, the maximum write-capable width, are different from each of the write units. Information intrinsic to each of the write units, such as the resolutions and the maximum write-capable widths, is stored in the storage unit to be described later.

The differences in the resolutions and the maximum write-capable widths between the respective write units are sometimes caused in the case where the write units are manufactured in advance to have densities of 600 dpi and 1200 dpi, or in the case where there are errors on specifications, which are caused by conversion of weights and measures. For example, for the write unit 3Y for writing the color of Y as a visually inconspicuous color, a write unit having a resolution of 600 dpi, which has a lower resolution but costs less, is used. Further, for the write unit 3K for writing the color of BK that is frequently used and visually conspicuous, a write unit having a resolution of 1200 dpi, which costs more but has a higher resolution, is used. Therefore, the cost of the entire apparatus can be suppressed without decreasing apparent quality of the formed image.

Above the photoconductor drums 1Y, 1M, 1C, 1K, there are provided sensors SE1, SE2, SE3 and SE4 such as optical sensors which detect the maximum development widths in the main scanning direction by the developing units 4Y, 4M, 4C and 4K, that is, the above-described maximum write-capable widths. The sensors SE1, SE2, SE3 and SE4 are provided in lines in the main scanning direction at positions with substantially the maximum widths of the development performed in the developing units 4Y, 4M, 4C and 4K, detect adhering states of the toners when the development is performed at the maximum widths in the main scanning direction, and output the detected signals to the control unit to be described later.

Note that the sensors SE1, SE2, SE3 and SE4 not only detect the maximum write-capable widths but also may detect the shifts between predetermined pattern images formed by the developing units 4Y, 4M, 4C and 4K. Therefore, the sensors can detect differences between designed resolutions and actual resolutions, and can output the detected signals to the control unit to be described later.

Here, a description will be made of an outline of an image forming process. The images of the respective colors, which are formed by the image forming units 10Y, 10M, 10C and 10K, are sequentially transferred onto the rotating intermediate transfer body 6 by primary transfer rollers 7Y, 7M, 7C and 7K to which primary transfer biases (not particularly shown) having an inverse polarity (for example, a positive polarity) to the polarity of the toners for use are applied. Thereby, a color image (color toner image) synthesized by superimposing the colors is formed (primary transfer).

Moreover, below the image forming section 60, feed trays 20A, 20B and 20C which house the recording media to be fed to the image forming section 60 are provided. The recording media P housed in the feed tray 20A and the like are fed by sending rollers 21 and feed rollers 22A, which are provided on the feed tray 20A and the like, pass through conveyor rollers 22B, 22C and 22D, resist rollers 23, and the like, and are conveyed to secondary transfer rollers 7A. Then, the color image is transferred in a lump from the intermediate transfer body 6 to one-side surfaces (surfaces) of the recording media P.

The fixing processing is performed for the recording media P to which the color image is transferred, by the fixation device 17. The recording media P are sandwiched by discharge rollers 24, and are mounted on a discharge tray 25 outside of the color copier 100. The remaining toners which remain on circumferential surfaces of the photoconductor drums 8Y, 8M, 8C and 8K after the transfer, are removed by the cleaning members 8Y, 8M, 8C and 8K, and then the image forming section 60 enters the next image forming cycle.

In the case of forming the images on both surfaces of the recording media P, after the images are formed on the one-side surface, the recording media P discharged from the fixation device 17 are branched from such a discharge passage by a branching member 26. Subsequently, the recording media P pass through a paper circulating passage 27A located below, are inverted upside down by an inversion conveyor passage 27B as a re-feed mechanism (ADU mechanism), pass through a re-feed conveyor unit 27C, and then meet the above-described transfer route from the conveyor roller 22D.

The inverted and conveyed recording media P pass through the resist rollers 23, and are conveyed again to the secondary transfer rollers 7A. Then, the color image (toner image) is transferred in a lump onto the other-side surface (back surface) of the recording medium P. Meanwhile, with regard to the intermediate transfer body 6 that has performed self stripping for the recording media P, after transferring the color image thereto by the secondary transfer rollers 7A, the remaining toners are removed by a cleaning member 8A for the intermediate transfer belt.

As the recording media P on which the image is formed, there are used thin paper having a 1000-piece unit weight of approximately 52.3 to 63.9 kg/m², plain paper having a 1000-piece unit weight of approximately 64.0 to 81.4 kg/m², thick paper having a 1000-piece unit weight of approximately 83.0 to 130.0 kg/m², and ultra-thick paper having a 1000-piece unit weight of approximately 150.0 kg/m². The thickness (paper thickness) of the recording medium P ranges approximately from 0.05 to 0.15 mm.

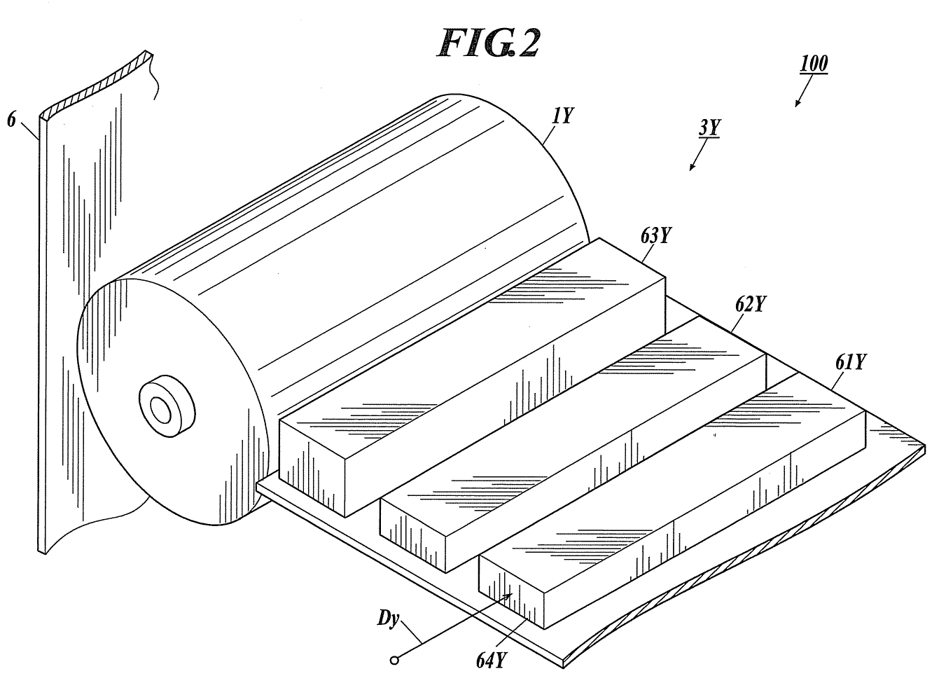

Here, a description will be made of a peripheral configuration of the image forming section which forms the image, by taking a periphery of the write unit 3Y as an example. As shown in FIG. 2, the write unit 3Y is provided at a position opposite to the photoconductor drum 1Y. The write unit 3Y includes an IC package board 64Y. A register array 61Y formed into an integrated circuit (IC), a latch circuit 62Y and an LED head 63Y are packaged on the IC package board 64Y, and are connected to one another by a printed wiring board (not shown) and the like. For the write unit 3Y and the like, an LED array head optical unit is used, for example, in which light emitting elements (LEDs) having 7500 pixels and a resolution of 600 dpi for an A4 size are arranged in lines in the main scanning direction. The LED array head optical unit generates an LED light group for forming one Y-color line with each intensity based on image data for one line at one time.

The LED light group for the color of Y exposes one line of the photoconductor drum 1Y at one time, and forms the electrostatic latent image in line in the main scanning direction. The developing unit 4Y shown in FIG. 1 develops the linear electrostatic latent image formed on the photoconductor drum 1Y by the Y-color toner member. The toner image for the color of Y, which is developed by the developing unit 4Y, is transferred to the intermediate transfer body 6.

Note that, in this embodiment, also for the C-color write unit 3C and the M-color write unit 3M, LED array head optical units in which light emitting elements (LEDs) having the resolution of 600 dpi, which is the same specification as that of the Y-color write unit 3Y, are arranged in lines in the main scanning direction, are used. Meanwhile, for the BK-color write unit 3K, an LED array head optical unit in which light emitting elements (LEDs) having a resolution of 1200 dpi are arranged in lines in the main scanning direction, is used.

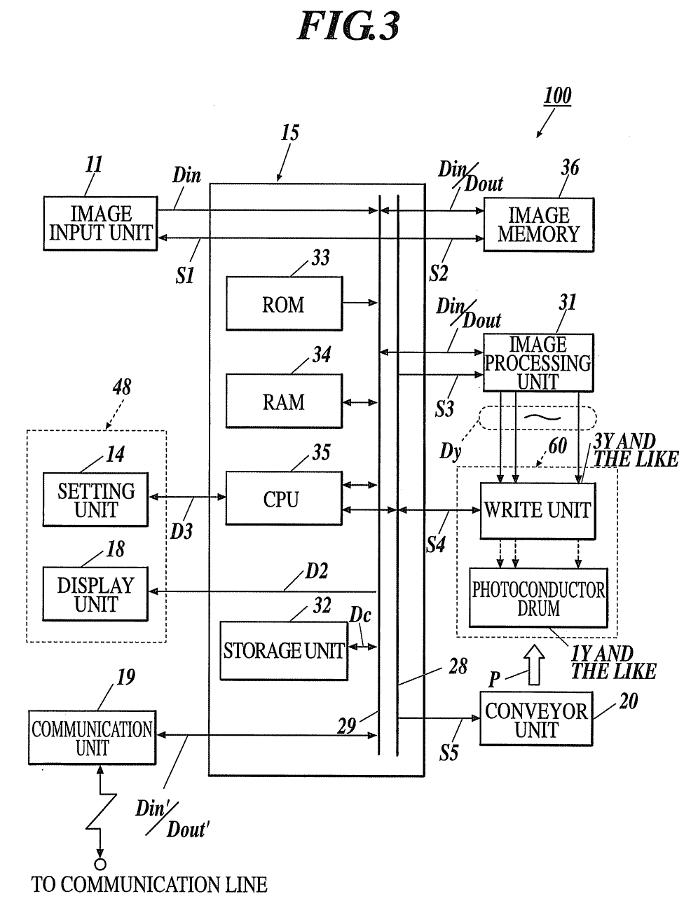

Next, a description will be made of a control system of the color copier 100. As shown in FIG. 3, the color copier 100 includes: the image input unit 11; the control unit 15; a communication unit 19; a conveyor unit 20; the image processing unit 31; an image memory 36; an operation panel 48; and the image forming section 60.

The control unit 15 includes: a read only memory (ROM) 33; a random access memory (RAM) 34 for work; and a central processing unit (CPU) 35. In the ROM 33, system program data for controlling the entirety of the copier is stored. The ROM 33 stores setting information intrinsic to the copier, such as the number of pixels (number of lines) in the main scanning direction/sub scanning direction in which the image forming section 60 forms the image on the recording media P, and program data executable by the control unit 15, and the like. The RAM 34 provides a storage area for temporarily storing a control command when a both-surface mode is executed, and for work in operation processing to be described later. When a power supply is turned on, the CPU 35 reads out the system program data from the ROM 33, activates a system of copier, and controls the entirety of the copier.

The operation panel 48 includes a setting unit 14 formed of a touch panel, and a display unit 18 such as a liquid crystal display (LCD), and receives inputs for displaying and setting an operation screen under the control of the control unit 15. The setting unit 14 is connected to the above-described control unit 15, and is operated so as to input a paper type of the recording media P on which the image is formed by the image forming section 60, and image forming conditions (setting of an image density, selection of a paper size, setting of the number of copies, and the like) on the one-side surface or both-side surfaces.

Moreover, in the setting unit 14, besides the above-described operation, an operation input for setting information regarding the resolutions, the maximum write-capable widths and the like in the above-described respective write units, is performed. Specifically, a guide screen for selecting the write units of Y, M, C and BK is displayed on the display unit 18, and selection of any of the write units is received from the setting unit 14. Subsequently, a setting screen for setting the information regarding the resolutions, the maximum write-capable widths and the like, which is related to the selected write unit, is displayed on the display unit 18, and from the setting unit 14, the input of setting values is performed by inputting numeric values, selecting fine adjustment steps which are approximately +five steps, and the like.

Note that setting contents of the resolutions, the maximum write-capable widths and the like in the respective write units, which are inputted from the above-described operation panel 48, are temporary stored in a work area of the RAM 34 under the control of the control unit 15. Then, in response to an instruction input reflecting the setting contents, contents of data stored in a storage unit 32 to be described later are updated, and the updated contents of data are stored.

In this example, systems such as a control bus 28 and a data bus 29 are connected to the above-described CPU 35. To the data bus 29, the display unit 18 is connected. The display unit 18 reduces and previews the originals 30 based on image data Din obtained by the image input unit 11, and displays selection items and the like related to the image forming conditions based on display data D2 sent from the CPU 35. Note that the image forming conditions, feeder cassette selection information, and the like, which are set on the operation panel 48, are outputted to the CPU 35 as operation data D3.

To the CPU 35, the storage unit 32 is connected through the control bus 28 and the data bus 29. The storage unit 32 stores the information regarding the resolution specifications, the maximum write-capable widths and the like in the respective write units. The image processing unit 31 scales each of the image data for forming the image in each of the write units based on the information described above, and solves a printing position shift that is based on differences in resolution specification and maximum printing width among the respective write units.

The image input unit 11 is connected to the above-described control bus 28 and data bus 29. In the image input unit 11, an analog/digital converter (not shown) is provided. The image input unit 11 performs the A/D conversion for the analog image reading signals obtained by being read from the originals 30 based on a reading control signal S1. Digital image data Din obtained by the A/D conversion is transferred to the image memory 36 connected to the control bus 28 and the data bus 29.

The data Din is stored in the image memory 36 based on a memory control signal S2. For the image memory 36, a hard disk, a semiconductor storage memory and the like are used. The reading control signal S1 is outputted to the image input unit 11 from the CPU 35 through the control bus 28, and in a similar way, the memory control signal S2 is outputted from the CPU 35 to the image memory 36. The CPU 35 executes write/read controls for the data in the image memory 36.

The image processing unit 31 stores in advance the three-dimensional color information conversion table in a memory (not particularly shown), and performs color conversion for image data Dout (=Dr, Dg and Db) of the RGB color system, which is read out of the image memory 36, into the image data Dy, Dm, Dc and Dk of the YMCK color system based on an image processing control signal S3.

The image processing unit 31 supplies the image data Dy to the write unit 3Y of the image processing unit 60 per line and per pixel. For the image processing unit 31, a digital signal processor (DSP), a RAM, and the like are used. In the RAM, a work area (line buffer) for supplying the image data Dy per line and per pixel is provided, and line data for which the image processing has been performed, is temporarily stored before being supplied. Specifically, the RAM is configured to store the line data which corresponds to the image forming for one line in the main scanning direction, in multi-stages.

In the color copier 100, under the control of the control unit 15, adjustment of an image forming position in the main scanning direction is performed by shifting the line data of the image processing unit 31. In a similar way, in the color copier 100, under the control of the control unit 15, adjustment of an image forming position in the sub scanning direction is performed by delaying the reading of the line data of the image processing unit 31 or pre-reading the line data by several stages.

The image forming section 60 is connected to the above-described control bus 28 and data bus 29. The image forming section 60 is composed of the image forming units 10Y, 10M, 10C and 10K shown in FIG. 1. In FIG. 3, only the image forming unit 11Y for the color of Y is shown. The image forming unit 10Y composing the image forming section 60 includes the write unit 3Y in which the plurality of light emitting members are arrayed in lines, and the photoconductor drum 1Y on which the image is formed by the write unit 3Y. Since the other image forming units 10M, 10C and 10K for the colors of M, C and BK are similar to the image forming unit 10Y, a description thereof will be omitted. In this example, the CPU 35 outputs an image forming control signal S4 to the image forming section 60 through the control bus 28.

For example, the Y-color write unit 3Y of the image forming section 60 operates to form the toner image for the color of Y on the photoconductor drum 1Y in response to input of the image data Dy for the color of Y per line and the image forming control signal S4 under the control of the control unit 15. In the write unit 3Y, the LED light group for forming the one Y-color line is generated at one time with each intensity thereof based on the image data Dy for one line. The LED light group for the color of Y exposes one line of the photoconductor drum 1Y at one time, and forms the linear electrostatic latent image. The developing unit 4Y shown in FIG. 1 develops the linear electrostatic latent image formed on the photoconductor drum 1Y by the Y-color toner member. The toner image for the color of Y, which is developed by the developing unit 4Y, is transferred to the intermediate transfer body 6.

To the control bus 28, the conveyor unit 20 is connected, and the CPU 35 controls the feed trays 20A, 20B and 20C shown in FIG. 1 based on a feed control signal S5. For example, the conveyor unit 20 selects any of the feed trays 20A, 20B and 20C based on the feed control signal S5, and conveys the recording media P, which are fed out of the feed tray 20A, 20B or 20C, to the image forming section 60. The feed control signal S5 is supplied from the CPU 35 to the conveyor unit 20.

To the data bus 29, the communication unit 19 is connected. The communication unit 19 is connected to a communication line such as a local area network (LAN), and is used when communication processing is performed with external computer, printer and the like. For example, when an image of an original read by the color copier 100 is formed and outputted by the external printer, the communication unit 19 transmits image data Dout′ to the external printer. Note that such a communication function of the communication unit 19 is utilized also when image data Din′ created in the external computer is received and printing processing is performed therefor in the image forming section 60 under the control of the control unit 15.

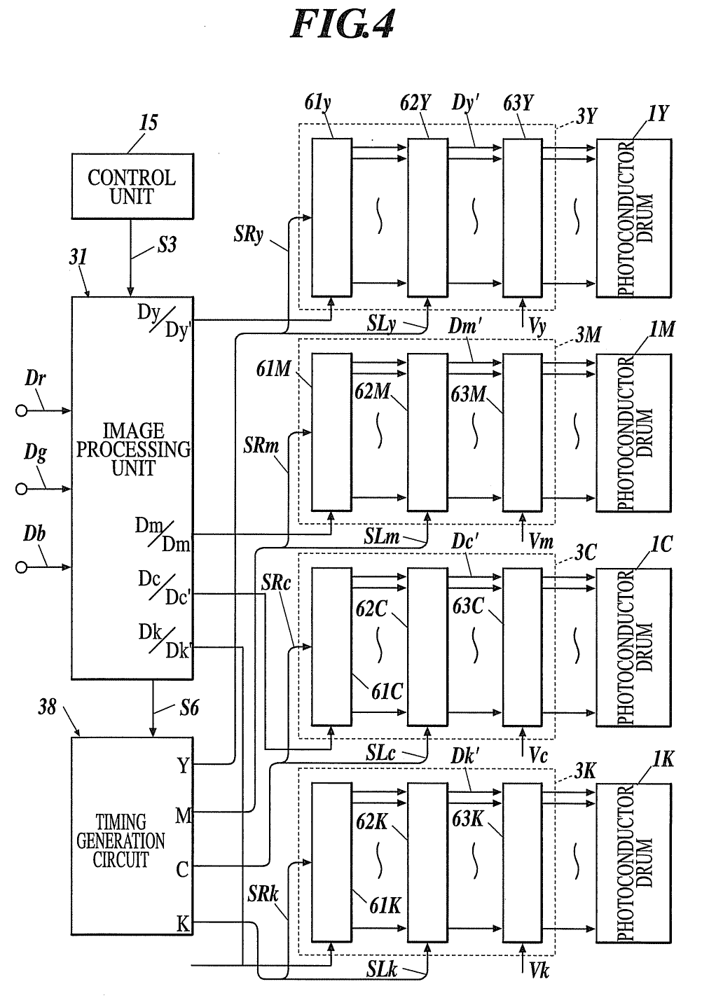

Next, a description will be made of configurations of the respective LED write units for the colors of Y, M, C and BK and a peripheral circuit thereof. As shown in FIG. 4, the image processing unit 31 is connected to the CPU 35. The image processing control signal S3 is supplied from the CPU 35 to the image processing unit 31. The image processing unit 31 converts the digital image data Din (=Dr, Dg, Db) of the color components of R, G and B into write data for LED writing based on the image processing control signal S3. For example, the image processing unit 31 converts the image data Din into the image data Dy, Dm, Dc and Dk for the colors of Y, M, C and BK by the three-dimensional color information conversion table.

Moreover, when an image processing control signal S3 including scale factors in the main scanning direction of the respective units is supplied in such a manner that the CPU 35 reads out the information regarding the resolution specifications and the maximum write-capable widths in the respective write units, the image processing unit 31 converts the above-described scaled image data Dy, Dm, Dc and Dk into image data Dy′ Dm′, Dc′ and Dk′ in the main scanning direction in response to the scale factors.

In this example, the image processing unit 31 supplies the image data Dy or the image data Dy′ per line and per pixel to the register array 61Y of the write unit 3Y. In a similar way, the image processing unit 31 supplies the image data Dm or the image data Dm′ per line and per pixel to the register array 61M of the write unit 3M. In a similar way, the image processing unit 31 supplies the image data Dc or the image data Dc′ per line and per pixel to the register array 61C of the write unit 3C. In a similar way, the image processing unit 31 supplies the image data Dk or the image data Dk′ per line and per pixel to the register array 61K of the write unit 3K.

To the image processing unit 31, a timing generation circuit 38 is connected. The image processing unit 31 supplies a timing generation control signal S6 to the timing generation circuit 38. Based on the timing generation control signal S6, the timing generation circuit 38 individually generates a register control signal SRy and a latch control signal SLy for the color of Y, a register control signal SRm and a latch control signal SLm for the color of M, a register control signal SRc and a latch control signal SLc for the color of C, and a register control signal SRk and a latch control signal SLk for the color of BK.

To the image processing unit 31 and the timing generation circuit 38, the write units 3Y, 3M, 3C and 3K for the respective colors of Y, M, C and BK are connected. The write unit 3Y includes: the register array 61Y; the latch circuit 62Y; and the LED head 63Y. To the above-described image processing unit 31, the register array 61Y is connected. The register array 61Y is adapted to sequentially receive the serial image data Dy/the image data Dy′ (here, “/” stands for “or” and is used hereinafter in the same meaning) for one line based on the register control signal SRy, and to hold the image data Dy/the image data Dy′.

To the register array 61Y, the latch circuit 62Y is connected, and the latch circuit 62Y operates so as to latch the image data Dy/the image data Dy′ outputted in parallel from the register array 61Y based on the latch control signal SLy. To the latch circuit 62Y, the LED head 63Y is connected. The LED head 63Y is connected to a laser drive power supply Vy. The LED head 63Y generates the LED light group for forming the one Y-color line at one time with each intensity based on the image data Dy/the image data Dy′ for one line, which is supplied from the latch circuit 62Y.

The LED light group for the color of Y exposes one line of the photoconductor drum 1Y at one time, and forms the linear electrostatic latent image. The developing unit 4Y shown in FIG. 1 develops the linear electrostatic latent image formed on the photoconductor drum 1Y by the Y-color toner member. The toner image for the color of Y, which is developed by the developing unit 4Y, is transferred to the intermediate transfer body 6.

The write unit 3M includes: the register array 61M; the latch circuit 62M; and the LED head 63M. To the above-described image processing unit 31, the register array 61M is connected. The register array 61M is adapted to sequentially receive the serial image data Dm/the image data Dm′ for one line based on the register control signal SRm, and to hold the image data Dm/the image data Dm′.

To the register array 61M, the latch circuit 62M is connected, and the latch circuit 62M operates so as to latch the image data Dm/the image data Dm′ outputted in parallel from the register array 61M based on the latch control signal SLm. To the latch circuit 62M, the LED head 63M is connected. The LED head 63M is connected to a laser drive power supply Vm. The LED head 63M generates, the LED light group for forming the one M-color line at one time with each intensity based on the image data Dm/the image data Dm′ for one line, which is supplied from the latch circuit 62M.

The LED light group for the color of M exposes one line of the photoconductor drum 1M at one time, and forms the linear electrostatic latent image. The developing unit 4M shown in FIG. 1 develops the linear electrostatic latent image formed on the photoconductor drum 1M by the M-color toner member. The toner image for the color of M, which is developed by the developing unit 4M, is transferred to the intermediate transfer body 6.

The write unit 3C includes: the register array 61C; the latch circuit 62C; and the LED head 63C. To the above-described image processing unit 31, the register array 61C is connected. The register array 61C is adapted to sequentially receive the serial image data Dc/the image data Dc′ for one line based on the register control signal SRc, and to hold the image data Dc/the image data Dc′.

To the register array 61C, the latch circuit 62C is connected, and the latch circuit 62C operates so as to latch the image data Dc/the image data Dc′ outputted in parallel from the register array 61M based on the latch control signal SLc. To the latch circuit 62C, the LED head 63C is connected. The LED head 63C is connected to a laser drive power supply Vc. The LED head 63C generates the LED light group for forming the one C-color line at one time with each intensity based on the image data Dc/the image data Dc′ for one line, which is supplied from the latch circuit 62C.

The LED light group for the color of C exposes one line of the photoconductor drum 1C at one time, and forms the linear electrostatic latent image. The developing unit 4C shown in FIG. 1 develops the linear electrostatic latent image formed on the photoconductor drum 1C by the C-color toner member. The toner image for the color of C, which is developed by the developing unit 4C, is transferred to the intermediate transfer body 6.

The write unit 3K includes: the register array 61K; the latch circuit 62K; and the LED head 63K. To the above-described image processing unit 31, the register array 61K is connected. The register array 61K is adapted to sequentially receive the serial image data Dk/the image data Dk′ for one line based on the register control signal SRk, and to hold the image data Dk/the image data Dk′.

To the register array 61K, the latch circuit 62K is connected, and the latch circuit 62K operates so as to latch the image data Dk/the image data Dk′ outputted in parallel from the register array 61K based on the latch control signal SLk. To the latch circuit 62K, the LED head 63K is connected. The LED head 63K is connected to a laser drive power supply Vk. The LED head 63K generates the LED light group for forming the one BK-color line at one time with each intensity based on the image data Dk/the image data Dk′ for one line, which is supplied from the latch circuit 62K.

The LED light group for the color of BK exposes one line of the photoconductor drum 1K at one time, and forms the linear electrostatic latent image. The developing unit 4K shown in FIG. 1 develops the linear electrostatic latent image formed on the photoconductor drum 1K by the BK-color toner member. The toner image for the color of BK, which is developed by the developing unit 4K, is transferred to the intermediate transfer body 6. The toner images transferred to the intermediate transfer body 6 are transferred to a predetermined recording medium P. Thereby, the color image is formed.

Here, a description will be made of an internal configuration of the image processing unit 31 that supplies the image data Dy/Dy′, the image data Dm/Dm′, the image data Dc/Dc′, and the image data Dk/Dk′, which are supplied to the respective LED write units for the colors of Y, M, C and BK, based on the image processing control signal S3 from the CPU 35.

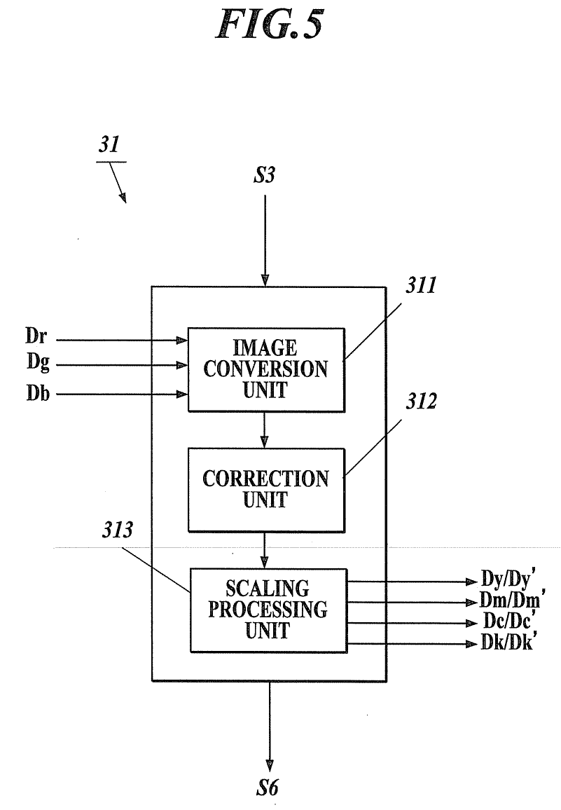

As shown in FIG. 5, the image processing unit 31 is configured by including: an image conversion unit 311; a correction unit 312; and a scaling processing unit 313. The image conversion unit 311 converts the inputted digital image data Din (=Dr, Dg, Db) of the color components of R, G and B into the image data for the colors of Y, M, C and BK with reference to the three-dimensional color information conversion table and the like. The correction unit 312 performs resist correction for the converted image.

Note that, when the image data is converted into the image data for the respective colors of Y, M, C and BK, the image conversion unit 311 may perform gradation conversion therefor by referring to a table and the like for the gradation conversion. Specifically, when the number of gradations of each color of Y, M, C and BK is 256, the image conversion unit 311 converts the image data into 16 gradations or two gradations (binarization) which indicate ON/OFF.

The scaling processing unit 313 performs scaling in the main scanning direction, which is instructed by the image processing control signal S3, for the image data (of the respective colors of Y, M, C and BK) after being corrected, that is, scaling in a direction corresponding to the main scanning direction of the respective write units. The scaling processing unit 313 outputs the image data Dy′, Dm′, Dc′ and Dk′ in the case of performing the scaling based on the image processing control signal S3, and outputs the corrected image data as the image data Dy, Dm, Dc and Dk in the case of not performing the scaling.

The image processing control signal S3 is set by calculation which is performed so that the CPU 35 reads the information regarding the resolution specifications, the maximum printing widths, and the like. The image processing control signal S3 includes the scale factors which are based on a ratio of the resolutions among the respective write units, a ratio of the maximum printing widths thereamong, and the like. The scaling processing unit 313 performs the scaling in the main scanning direction in accordance with the scale factors concerned.

With regard to setting of the scale factors in the CPU 35, the information regarding the resolution and the maximum printing width in the main scanning direction of the write unit that forms a predetermined color is taken as a reference. Then, based on the information regarding the resolutions and maximum printing widths of the write units of the other colors, the scale factors are set to the values that allow writing positions of the write units of the other colors to coincide with a writing position of the write unit as the reference.

With respect to the write unit which is the reference, the write units of the colors of C, M and Y having low resolution specifications are set based on the setting information in the storage unit 32. In this case, since the adjustment is performed by using the color in which the resolution is the highest, apparent quality of the formed image is not decreased. Moreover, the write unit in which the resolution is the lowest may be set as the reference by comparing the respective pieces of the information regarding the resolutions of the respective write units, which are set in the storage unit 32, with one another. In this case, image forming is performed based on the scaling in the write unit in which the resolution is higher, and accordingly, the adjustment can be finely performed, and high-quality image forming can be performed.

For example, when the resolution specification of the BK-color write unit is 1198.0 dpi, and the resolution specifications of the YMC-color write units are 600.0 dpi, the writing position of the color of BK is fit to the writing positions of the colors of Y, M and C in which the resolutions are lower. In this case, a width of one pixel of the colors of Y, M and C is equivalent to a width of 1.97 pixels of the color of BK. Accordingly, in order to fit one pixel of the colors of Y, M and C to two pixels of the color of BK, the scale factor of the color of BK in the main scanning direction is set to 1.002. Specifically, here, by scaling the main scanning direction of the color of BK, a scale factor is set so that a resolution ratio between the color of BK and the colors of Y, M and C is set to an integer ratio. This is represented as in the following equation:

(first resolution/second resolution)×magnification=N

(N is an integer: 2 in this example)

Note that, although not particularly illustrated, also when the printing widths are set, a scale factor calculated from a printing width ratio between the mutual write units is set in a similar way.

Moreover, in the case of using write units in which the resolution specifications are different also among the colors of Y, M and C, a write unit in which the resolution is the lowest is taken as a reference (second resolution), and the scale factors of the write units of the respective colors may be decided in a similar manner to the above.

Based on the image processing control signal S3 including the above-described scale factors set in the CPU 35, the scaling processing unit 313 performs pixel thinning/pixel insertion which are based on the scale factors, for the image data which is stored in the line buffer and is to be supplied to the image forming section 60 per line and per pixel in the main scanning direction. Then, the scaling processing unit 313 outputs the scaled image data (image data Dy′ and the like). For example, when scaling of 0.999 time is performed, one pixel among 1000 pixels is thinned. When scaling of 1.002 times is performed, two pixels are inserted into 1000 pixels. Note that the pixel thinning/pixel insertion in the scaling processing unit 313 based on the scale factors, are performed at random positions on the line, and accordingly, an image blur that appears as a line in the sub scanning direction can be prevented.

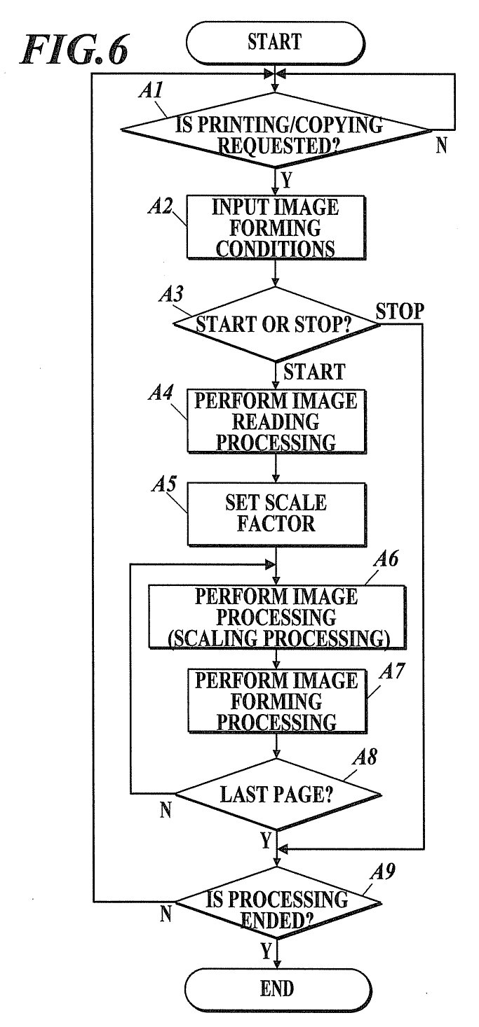

Next, a description will be specifically made of the operation (image forming) of the color copier 100, which is performed by the control of the control unit 15. As shown in FIG. 6, the operation of the color copier 100 is composed of each processing of Steps A1 to A9, which is performed in such a manner that the control unit 15 controls each unit.

As shown in FIG. 6, the control unit 15 determines whether or not there is a request for the image forming, such as printing/copying, by a printing request from another computer via the communication unit 19 or an operation instruction from the operation panel 48, and the control unit 15 is on standby until the above-described request is made (Step A1).

When the request for the image forming is made (Step S1: Y), the control unit 15 receives input of the image forming conditions related to the request based on the communication via the communication unit 19 or the input operation to the operation panel 48, and stores the information in the storage unit 32 (Step S2). Note that the input of the image forming conditions in Step A2 includes the setting of the information regarding the above-described resolutions and maximum write-capable widths in the respective write units. Moreover, the processing based on the printing request and the processing based on the copying request are substantially the same, and are only different from each other in that the processing based on the copying request includes image reading processing. Accordingly, a description will be made below of only the processing regarding the copying request, and a description of the printing request will be omitted.

Subsequently, the control unit 15 determines which of start and stop of the processing is instructed from the operation panel 48 and the like (Step A3), performs the image reading processing for reading the image from the image input unit 11 when the start is instructed (Step A4), and performs the setting of the scale factor by the above-described calculation operation of the CPU 35 (Step A5). Here, the setting of the scale factor, which is based on the above-described resolution specifications of the write units, is performed only in a color mode. Specifically, in a monochrome mode of performing the image forming by using only the BK-color write unit, the setting of the scale factor, which is based on the resolution specifications, is not performed. Note that the color mode and the monochrome mode are selectively set from the operation panel.

Subsequently, the control unit 15 outputs the image processing control signal S3 to the image processing unit 31, and the image processing including the scaling processing in the direction corresponding to the main scanning direction of the respective write units, is performed for the above-described image data (Step A6). Then, in the image forming section 60, the image forming processing is performed based on the rasterized image data (image data Dy/Dy′, image data Dm/Dm′, image data Dc/Dc′, and image data Dk/Dk′) for which the image processing has been performed (Step A7).

Subsequently, the control unit 15 performs determination processing for determining whether or not the image is formed on the last page (Step A8), and performs the image forming to the last page. Then, the control unit 15 determines whether or not the processing is to be ended by determining whether or not there is an instruction regarding the next processing, or the like (Step A9).

As described above, the color copier 100 is configured to set the scale factors in the main scanning direction for each of the write units of the respective colors of Y, M, C and BK and to scale the image data based on the set scale factors under the control of the control unit 15 in the case of creating the image data of the respective colors of Y, M, C and BK in the image processing unit 31 based on the image data Din inputted from the image input unit 11 and the like, and forming the image by superimposing the image on one another in the write units of the respective colors in the image forming section 60.

Therefore, although color shift occurs in the formed image owing to positional shifts in which the arrangements of the write-use light emitting elements in the main scanning direction in the write units of the respective colors are shifted from one another depending on the specifications, the color shift can be prevented by scaling the main scanning directions of the rasterized image data.

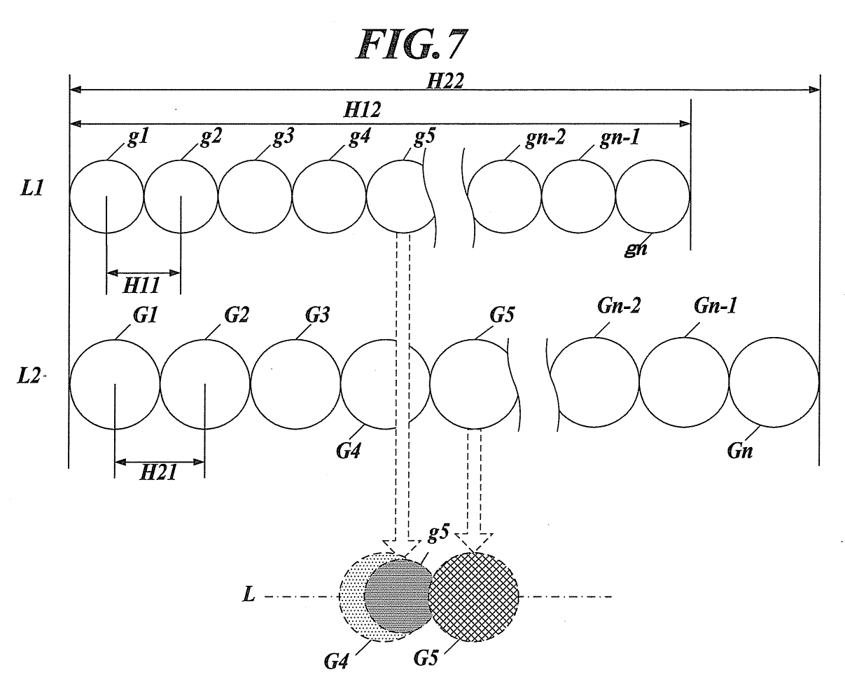

Specifically, the color shift in the formed image can be solved in the following manner. FIG. 7 shows a write element array L1 of pixels g1 to gn, in which a pixel interval H11 is a width (resolution) between the pixels, and a printing interval H12 is the maximum printing width, and a write element array L2 of pixels G1 to Gn, in which a pixel interval H21 is a width (resolution) between the pixels, and a printing width H22 is the maximum printing width. With regard to a positional shift between the pixels g5 and G5 formed on a printing line L by the rasterized image data before being scaled, for example, the rasterized image data on the write element array L1 side is scaled so that the pixel g5 is superimposed on a position of the pixel G4 on the write element array L2. In such a way, the color shift in the formed image can be solved.

Moreover, the color copier 100 is configured to set the scale factors in the main scanning direction of the rasterized image data corresponding to the main scanning direction based on the resolutions in the main scanning direction of the respective write units of the image forming section 60. Therefore, the color copier 100 can correct the writing positions in the respective write units based on the resolutions set for each of the write units, and can prevent the color shift.

Moreover, the color copier 100 is configured to set the scale factors so as to become an integer ratio between the resolutions in the main scanning direction of the respective write units. Therefore, the color copier 100 can correct the shifts of the wring positions, which occur in a unit of several percents owing to an error in manufacturing the respective write units, and the like, and can prevent the color shift.

Moreover, the color dopier 100 is configured to set the scale factors so that the scale factor of the write unit having the higher resolution can be matched with those of the write units having the lower resolution. The color copier 100 can obtain a high-definition formed image by correcting the color shift in the write unit having the higher resolution.

Moreover, the color copier 100 is configured to set the scale factors in the main scanning direction of the rasterized image data corresponding to the above-described main scanning direction based on the printing widths (writing widths) in the main scanning direction of the respective write units of the image forming section 60. Therefore, the color copier 100 can correct the writing positions in the respective write units based on the printing widths set for each of the write units, and can prevent the color shift.

Moreover, the color copier 100 is configured to receive the input of the information regarding the resolutions and printing widths of the respective write units by the operation input using the operation panel 48, and to thus make it possible to set the scale factor in the main scanning direction of the rasterized image data, which corresponds to the main scanning direction in the write units.

Moreover, the color copier 100 is configured to store the information regarding the resolutions and printing widths of the respective write units in the storage unit 32, and to thus make it possible to set the scale factor in the main scanning direction of the rasterized image data, which corresponds to the main scanning direction in the write units.

Moreover, the color copier 100 is configured to detect the information regarding the resolutions and printing widths of the respective write units by the sensors SE1 to SE4, and to thus make it possible to set the scale factor in the main scanning direction of the rasterized image data, which corresponds to the main scanning direction in the write units.

Moreover, the color copier 100 is configured to scale the rasterized image data, which is outputted from the image conversion unit 311, by the scaling processing unit 313. Therefore, it is possible to scale the rasterized image data in which the color gradations have been converted into binary values and the like by the image conversion unit 311.

Moreover, the color copier 100 is configured to randomly perform the pixel thinning or the pixel insertion which is related to the scaling when the scaling in the main scanning direction in the rasterized image data, which corresponds to the main scanning direction in the write units, is performed by the scaling processing unit 313. Therefore, the color copier 100 can prevent the image blur that is caused as a line or the like in the sub scanning direction by usual scaling processing.

Note that the above description of the embodiment merely illustrates an example, and the present invention is not limited to this. It is possible to appropriately change the configurations and the operations in the above-described embodiment within the scope without departing from the gist of the present invention.

Moreover, in this embodiment, the configuration in which the write-use light emitting elements related to the image forming, which are arrayed in lines in the main scanning direction, are the LED elements, and the image is formed by a so-called electrophotographic system, is shown. However, another configuration in which the write-use light emitting elements are ones including ink nozzles for ejecting ink, and the image is formed by a so-called ink jet system, may be adopted, and the present invention is not limited to this.

Moreover, the information stored in the storage unit 32 may be stored in ROMs provided in the respective write units. In this case, a manufacturer of the respective write units can set the information in advance at the time of shipment thereof, and can offer the information.

In accordance with one aspect of a preferred embodiment of the present invention, an image forming apparatus comprises each write unit for each color, in which light emitting elements are arrayed in line in a main scanning direction to superimpose images based on image data of each color and to form a color image;

a first write unit in which a resolution specification of an array of the light emitting elements is a first resolution;

a second write unit in which a resolution specification of an array of the light emitting elements is a second resolution;

a scale factor setting unit for setting a scale factor in the main scanning direction of the image data of the color corresponding to the first write unit or the second write unit based on the first resolution and the second resolution; and

a scaling unit for scaling the image data in the main scanning direction based on the set scale factor.

In this image forming apparatus, the color shift can be prevented in the case of forming the color image.

Preferably, in the image forming apparatus, the first resolution of the first write unit is higher than the second resolution of the second write unit, and the scale factor setting unit sets the scale factor in the main scanning direction of the image data of the color corresponding to the first write unit.

In this image processing apparatus, it is possible to set the scale factor in the main scanning direction of the image data of the color corresponding to the first write unit having the first resolution which is higher than the second resolution of the second write unit.

Preferably, in the image forming apparatus, the first write unit writes an image of black (BK), and the second write units writes an image of any one of cyan (C), magenta (M) and yellow (Y).

In this image forming apparatus, it is possible to prevent the color shift when the color image is formed by the second write unit for writing the image of one color of cyan (C), magenta (M) and yellow (Y).

Preferably, in the image forming apparatus, the scale factor setting unit sets the scale factor in the main scanning direction of the image data of any one color to a scale factor in which a ratio between the first resolution and the second resolution is an integer.

In this image forming apparatus, it is possible to set the scale factor in the main scanning direction of the image data of any one color to the scale factor in which a ratio between the first resolution and the second resolution is an integer.

Preferably, in the image forming apparatus, a monochrome mode of performing an image forming by using only the first write unit, and a color mode of performing the image forming by using all of the write units are provided, and the scale factor setting unit sets the scale factor based on the first resolution and the second resolution when the color mode is selected, and are inhibited from setting the scale factor based on the first resolution and the second resolution when the monochrome mode is selected.

In this image forming apparatus, when the color mode in which the image forming is performed by using all of the write units is selected, it is possible to set the scale factor based on the first resolution and the second resolution, and when the monochrome mode in which the image forming is performed by using only the first write unit is selected, it is possible to inhibit the setting of the scale factor based on the first resolution and the second resolution.

Preferably, the image forming apparatus further comprises:

a storage unit for storing each resolution information of the first write unit and the second write unit,

wherein the scale factor setting unit calculates and sets the scale factors based on the resolution information of the first write unit and the second write unit, which is read out from the storage unit.

In this image forming apparatus, it is possible to calculate and set the scale factors based on the resolution information of the first write unit and the second write unit, which is read out from the storage unit that stores the resolution information of the units.

Preferably, the image forming apparatus further comprises:

an operation unit for receiving an operation from a user, wherein resolution information inputted from the operation unit is stored in the storage unit as the resolution information of the first write unit and the second write unit.

In this image forming apparatus, the resolution information inputted from the operation unit for receiving the operation from the user can be stored in the storage unit as the resolution information of the units.

Preferably, the image forming apparatus further comprises:

a gradation conversion unit for converting a gradation of the image data of each color,

wherein the scaling unit scales the image data of which the gradation is converted.

In this image forming apparatus, it is possible to scale the image data of which the gradation is converted by the gradation conversion unit for converting the gradation of the image data of each color.

Preferably, in the image forming apparatus, the gradation conversion unit binarizes the gradation of the image data of each color, and

the gradation conversion unit performs pixel thinning or pixel insertion in the main scanning direction for the image data of each color, of which the gradation is binarized, based on the set scale factor.

In this image forming apparatus, based on the set scale factor, it is possible to perform the pixel thinning or the pixel insertion in the main scanning direction for the image data of each color, of which the gradation is binarized by the gradation conversion unit.

Preferably, in the image forming apparatus, the gradation conversion unit randomly performs the pixel thinning or the pixel insertion in the main scanning direction for pixels in the main scanning direction.

In this image forming apparatus, it is possible to randomly perform the pixel thinning or the pixel insertion in the main scanning direction for the pixels in the main scanning direction.

The present U.S. patent application claims the priority of Japanese Patent Application No. 2007-266768 filed on Oct. 12, 2007, according to the Paris Convention, and the above Japanese Patent Application is the basis for correcting mistranslation of the present U.S. patent application.

What is claimed is:

1. An image forming apparatus comprising each write unit for each color, in which light emitting elements are arrayed in line in a main scanning direction to superimpose images based on image data of each color and to form a color image;
a first write unit in which a resolution specification of an array of the light emitting elements is a first resolution;
a second write unit in which a resolution specification of an array of the light emitting elements is a second resolution;
a scale factor setting unit for setting a scale factor in the main scanning direction of the image data of the color corresponding to the first write unit or the second write unit based on the first resolution and the second resolution; and
a scaling unit for scaling the image data in the main scanning direction based on the set scale factor.

2. The image forming apparatus of claim 1,
wherein the first resolution of the first write unit is higher than the second resolution of the second write unit, and
the scale factor setting unit sets the scale factor in the main scanning direction of the image data of the color corresponding to the first write unit.

3. The image forming apparatus of claim 2,
wherein the first write unit writes an image of black (BK), and the second write units writes an image of any one of cyan (C), magenta (M) and yellow (Y).

4. The image forming apparatus of claim 1,
wherein the scale factor setting unit sets the scale factor in the main scanning direction of the image data of any one color to a scale factor in which a ratio between the first resolution and the second resolution is an integer.

5. The image forming apparatus of claim 1, wherein a monochrome mode of performing an image forming by using only the first write unit, and a color mode of performing the image forming by using all of the write units are provided, and
the scale factor setting unit sets the scale factor based on the first resolution and the second resolution when the color mode is selected, and are inhibited from setting the scale factor based on the first resolution and the second resolution when the monochrome mode is selected.

6. The image forming apparatus of claim 1, further comprising:
a storage unit for storing each resolution information of the first write unit and the second write unit,
wherein the scale factor setting unit calculates and sets the scale factors based on the resolution information of the first write unit and the second write unit, which is read out from the storage unit.

7. The image forming apparatus of claim 6, further comprising:
an operation unit for receiving an operation from a user,
wherein resolution information inputted from the operation unit is stored in the storage unit as the resolution information of the first write unit and the second write unit.

8. The image forming apparatus of claim 1, further comprising:
a gradation conversion unit for converting a gradation of the image data of each color,
wherein the scaling unit scales the image data of which the gradation is converted.

9. The image forming apparatus of claim 8,
wherein the gradation conversion unit binarizes the gradation of the image data of each color, and
the gradation conversion unit performs pixel thinning or pixel insertion in the main scanning direction for the image data of each color, of which the gradation is binarized, based on the set scale factor.

10. The image forming apparatus of claim 9,
wherein the gradation conversion unit randomly performs the pixel thinning or the pixel insertion in the main scanning direction for pixels in the main scanning direction.
